(19) United States
(12) Patent Application Publication
(10) Pub. No.: US 2016/0007113 A1
(43) Pub. Date: Jan. 7, 2016

(54) HEADPHONE OR HEADSET AND AUDIO PRODUCING DEVICE TO WHICH THE HEADPHONE OR HEADSET IS INTENDED TO BE CONNECTED

(71) Applicants: Frédéric GARREAU, Betton (FR); Erwan NOGUES, Rennes (FR); Christian COGNASSE, Thorigne Fouillard (FR); Mathieu CHACUN, La Brulatte (FR); Simon LEBRETON, Cesson Sevigne (FR); Freddy DAVID, Thorigne Fouillard (FR); Yannick LANDRE, Domagne (FR); Giuseppe TORRES, Vezin Le Coquet (FR); FRANCE BREVETS, Paris (FR)

(72) Inventors: Frédéric Garreau, Betton (FR); Erwan Nogues, Rennes (FR); Christian Cognasse, Thorigne Fouillard (FR); Mathieu Chacun, La Brulatte (FR); Simon Lebreton, Cesson Sevigne (FR); Freddy David, Thorigne Fouillard (FR); Yannick Landre, Domagne (FR); Giuseppe Torres, Vezin le Coquet (FR)

(73) Assignee: FRANCE BREVETS, Paris (FR)

(21) Appl. No.: 14/769,531

(22) PCT Filed: Feb. 22, 2013
(86) PCT No.: PCT/IB2013/000594

§ 371 Date: Aug. 21, 2015

(51) Int. Cl. H04R 1/10; G10K 11/178; H04R 5/033

(52) U.S. Cl. CPC H04R 1/1083; H04R 5/033; G10K 11/1786; H04R 2410/05; H04R 2420/09; G10K 2210/1081; G10K 2210/3046

(57) ABSTRACT

An audio system comprises an audio producing device and a headphone or a headset. The audio producing device transmits to the headphone or the headset left and right analog signals intended respectively for left or right analog speakers, and transmits to the headphone or the headset a power supply signal. The headphone or the headset comprises at least one digital microphone and means for superimposing digital data, resulting from sound captures performed by each digital microphone, on top of said left analog signal or on top of said right analog signal or on top of said power supply signal. The audio producing device further comprises means for separating the digital data from said left analog signal or from said right analog signal or from said power supply signal for further processing by the audio producing device. The audio producing device further comprises means for superimposing a clock signal intended to drive each digital microphone on top of said left and/or right analog signal. The headphone or the headset further comprises means for separating the clock signal from said left and/or right analog signal to drive each digital microphone.

The present invention generally relates to a headphone or a headset, and to an audio producing device to which the headphone or the headset is intended to be connected, wherein the headphone or the headset and the audio producing device are adapted to reduce an amount of interface wires for interconnecting the headphone or the headset and the audio producing device when at least one digital microphone is included in the headphone or the headset.

Digital microphones may be implemented in noise-cancelling headphones, or headsets, in order to reduce unwanted ambient sounds by means of active noise control—also known as audio noise cancellation. Noise-cancelling headphones, or headsets, implement one or more digital microphones placed near each ear of the person wearing the headphone, or the headset, and further implement circuitry that uses signals captured by the digital microphones to generate anti-noise signals. When reproduced by the speakers of the headphone, or of the headset, the generated anti-noise signals cancel out the ambient noise as heard by said person wearing the headphone, or the headset. Such headphones, or headsets, are therefore active in cancelling the audio noise and should not be confused with noise isolating headphones, or headsets.

In one exemplary known arrangement of ANC headphones or headsets, in order to be compliant with standard jack connectors, such as the TRRS (Tip Ring Ring Sleeve) 3.5 mm connector, an ANC circuitry and a battery have been implemented in the headphone, or in the headset.

Alternate ANC headphones, or headsets, rely on ANC circuitry in the audio producing device to which the headphone, or the headset, is intended to be connected, which further avoids implementing a battery in the headphone, or in the headset. However, such ANC headphones, or headsets implement non-standard connectors.

There is therefore a need to reduce an amount of interface wires for interconnecting the headphone or the headset and the audio producing device, in the scope of implementing ANC functionality.

Moreover, it would be advantageous to be able to provide headsets relying on a digital microphone for capturing the voice of the person wearing the headset. Indeed, a digital microphone would limit the impact of interference on the signal that results from the sound capture by the microphone and that is provided for further processing to the audio providing device. However, in view of the state of the art, implementing such a digital microphone for capturing the voice of the person wearing the headset implies implementing supplementary interface wires between the headset and the audio producing device, compared to implementing an analog microphone for capturing the voice of the person wearing the headset.

There is therefore a need to reduce the amount of interface wires for interconnecting the headset and the audio producing device, in the scope of implementing a digital microphone for capturing the voice of the person wearing the headset.

In the two contexts described above, it is more particularly desirable to provide a solution that allows relying on a standard TRRS connector for connecting the headphone or the headset to the audio producing device.

It is furthermore desirable to provide a solution that is simple and cost-effective.

To that end, the present invention concerns an audio system comprising an audio producing device and further comprising a headphone or a headset, the headphone or the headset comprising left and right analog speakers, the audio producing device being adapted to transmit to the headphone or the headset left and right analog signals intended respectively for the left or right analog speakers, the audio producing device being further adapted to transmit to the headphone or the headset a power supply signal. The audio system is such that: the headphone or the headset further comprises at least one digital microphone and further comprises means for superimposing digital data, resulting from sound captures performed by each digital microphone, on top of said left analog signal or on top of said right analog signal or on top of said power supply signal; the audio producing device further comprises means for separating the digital data from said left analog signal or from said right analog signal or from said power supply signal for further processing by the audio producing device; the audio producing device further comprises means for superimposing a clock signal intended to drive each digital microphone on top of said left and/or right analog signal; and the headphone or the headset further comprises means for separating the clock signal from said left and/or right analog signal to drive each digital microphone.

The present invention also concerns an audio producing device intended to be connected to a headphone or a headset, the audio producing device being adapted to transmit to the headphone or the headset left and right analog signals intended respectively for left or right analog speakers of the headphone or the headset, the audio producing device being further adapted to transmit to the headphone or the headset a power supply signal. The audio producing device is such that it comprises: means for separating digital data from the left or from the right analog signal or from the power supply signal for further processing by the audio producing device; and means for superimposing a clock signal intended to drive at least one digital microphone of the headphone or the headset on top of said left and/or right analog signal.

The present invention also concerns an audio device of headphone or headset type intended to be connected to an audio producing device, the audio device comprising left and right analog speakers, the audio device being adapted to receive from the audio producing device left and right analog signals intended respectively for the left or right analog speakers, the audio device being further adapted to receive a power supply signal from the audio producing device. The audio device is such that it further comprises: at least one digital microphone; means for superimposing digital data, resulting from sound captures performed by each digital microphone, on top of said left analog signal or on top of said right analog signal or on top of said power supply signal; and means for separating a clock signal from said left and/or right analog signal to drive each digital microphone.

Thus, by superimposing the clock signal onto the left or right analog signal and by superimposing the digital data onto the left analog signal or onto the right analog signal or onto the power supply signal, the number of interface wires to connect the audio producing device to the headphone or the headset is limited. Moreover, TRRS 4-pin 3.5 mm connectors can be used to connect the audio producing device to the headphone or headset.

The characteristics of the invention will emerge more clearly from a reading of the following description of an example of embodiment, said description being produced with reference to the accompanying drawings, among which:

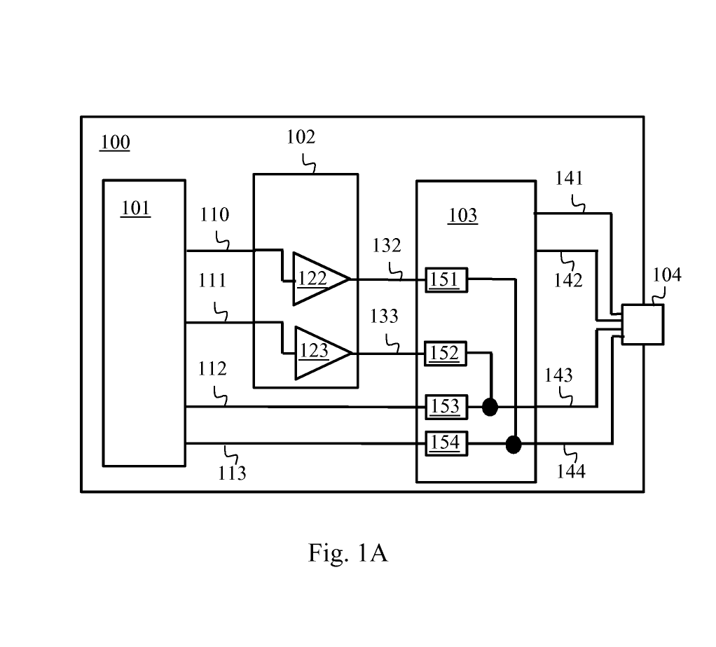

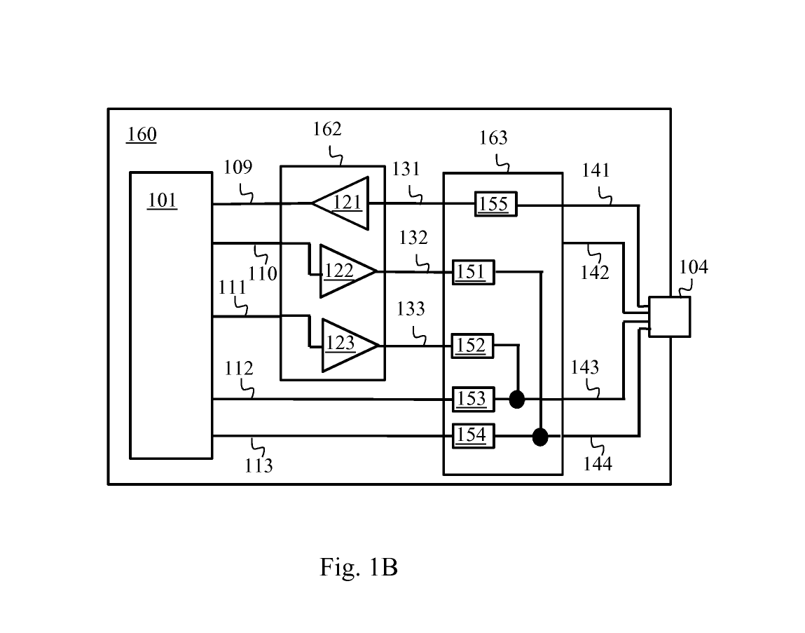

FIG. 1A schematically represents a first embodiment of an audio producing device;

FIG. 1B schematically represents a second embodiment of the audio producing device;

FIG. 1C schematically represents a third embodiment of the audio producing device;

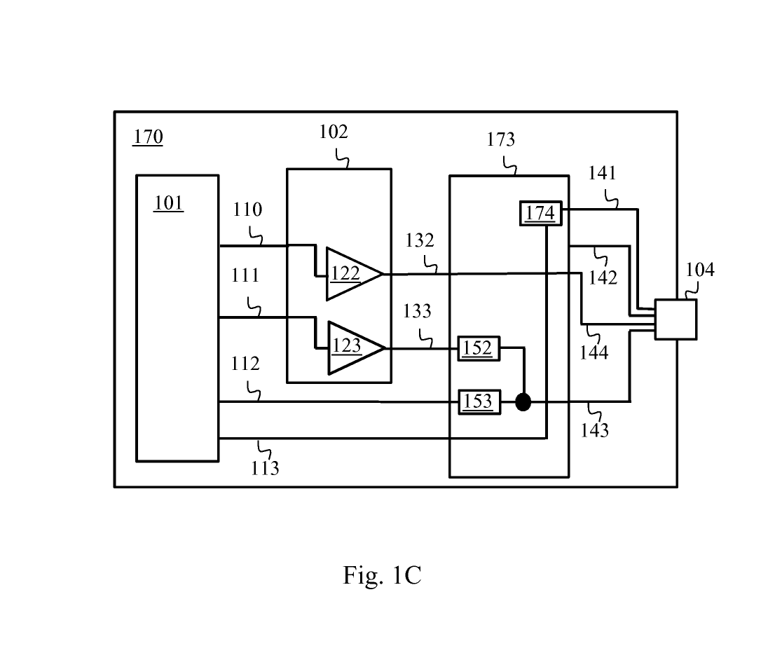

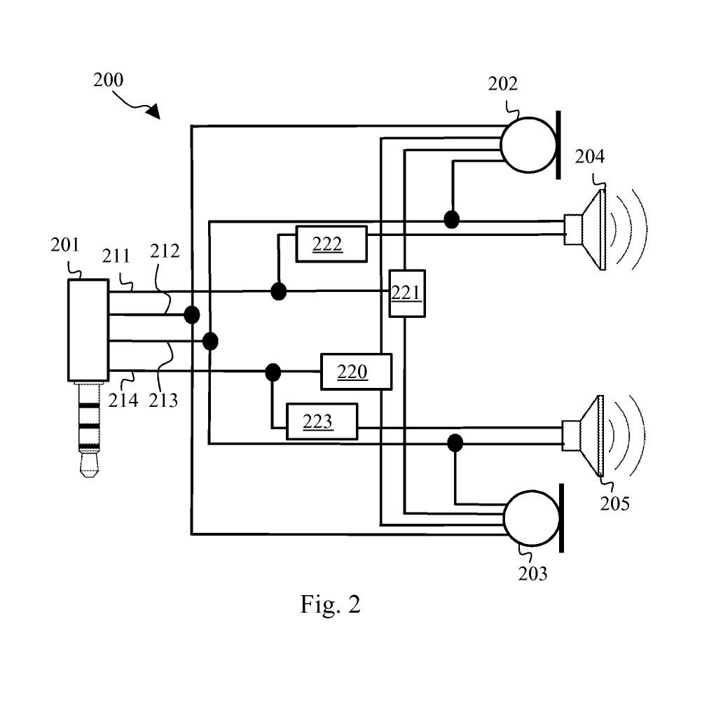

FIG. 2 schematically represents a first embodiment of a headphone;

FIG. 3 schematically represents a first embodiment of a headset;

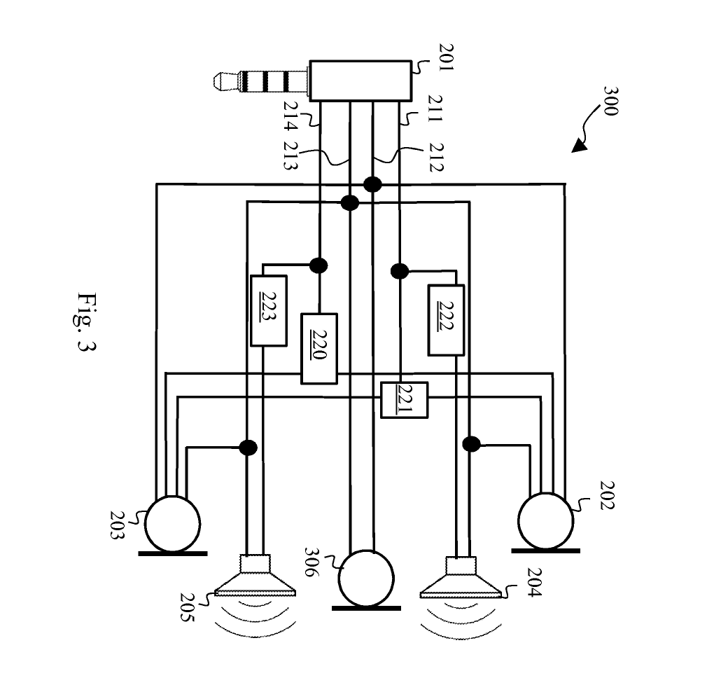

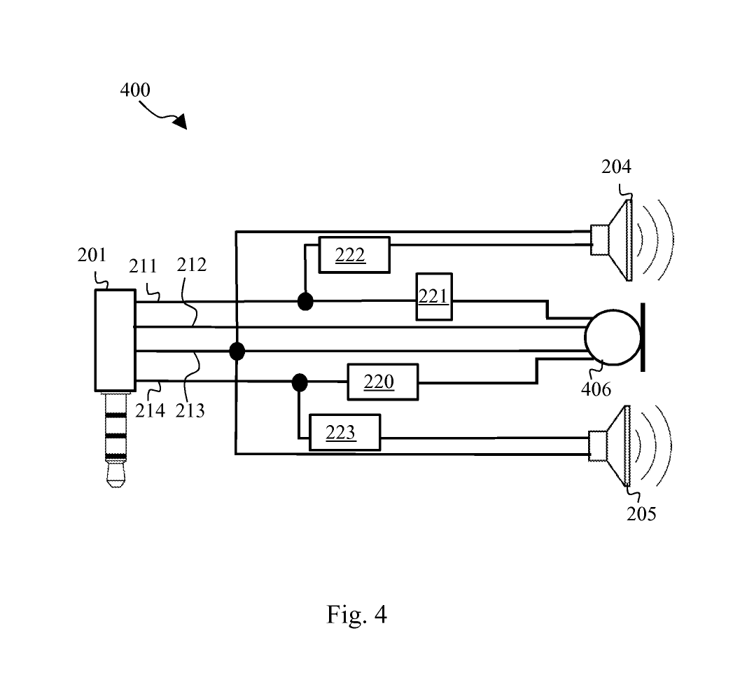

FIG. 4 schematically represents a second embodiment of the headset;

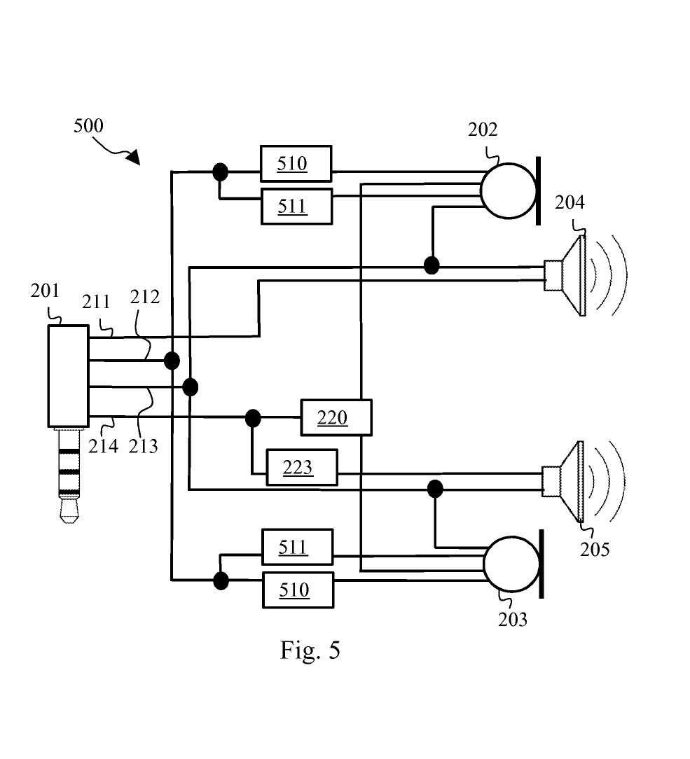

FIG. 5 schematically represents a second embodiment of the headphone;

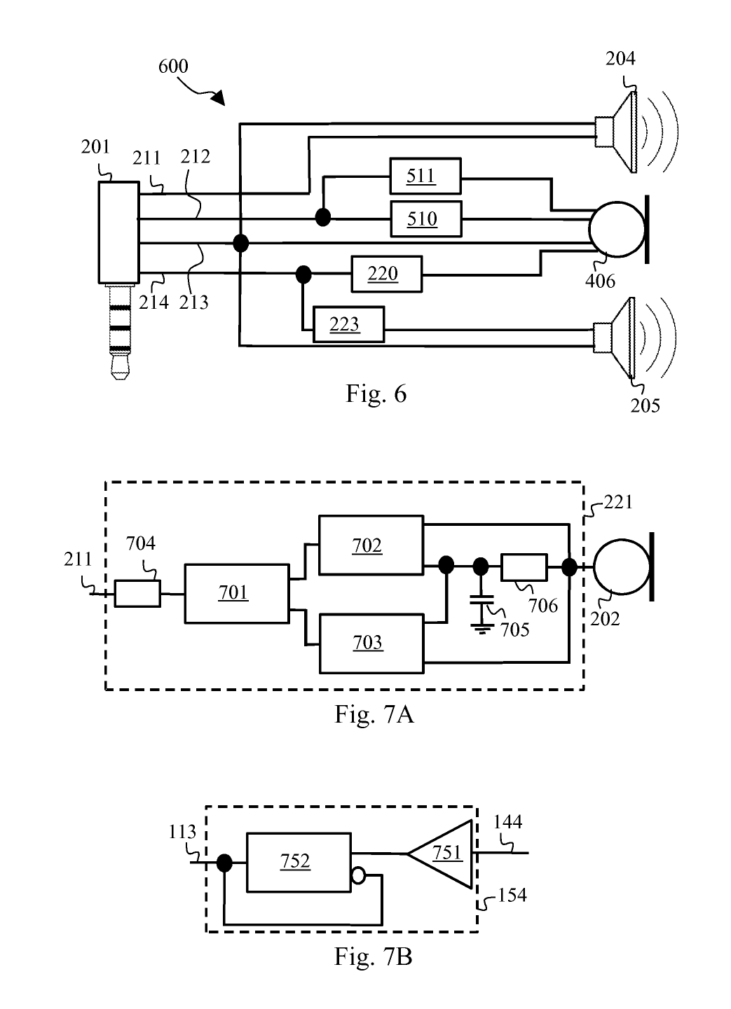

FIG. 6 schematically represents a third embodiment of the headset;

FIG. 7A schematically represents an adaptation unit or subunit implemented by the headphone of FIG. 2 or the headset of FIG. 3 or 4;

FIG. 7B schematically represents an adaptation unit or subunit implemented by the audio producing device of FIG. 1A or 1B.

FIG. 1A schematically represents a first audio producing device 100, FIG. 1B schematically represents a second audio producing device 160 and FIG. 1C represents a third audio producing device 170. The first 100, second 160 and third 170 audio producing devices are intended to be used with corresponding headphones or headsets.

Headsets and headphones are audio devices. A headset is particular embodiment of a headphone, in which a microphone is present for capturing the voice of the person wearing the headset. Typically, a headphone is a device including ear speakers, which are adapted to enable listening to an audio stereo signal provided by the first 100, second 160 or third 170 audio producing device; a headset is a device including ear speakers and a microphone, which is adapted to enable conversations handled by the second audio producing device 160.

A headphone embodiment compliant with the first audio producing device 100 is detailed hereafter with regard to FIG. 2. A headset embodiment compliant with the first audio producing device 100 is detailed hereafter with regard to FIG. 4. The headphone embodiment detailed hereafter with regard to FIG. 2 is compliant with the second audio producing device 160 too. A headset embodiment compliant with the second audio producing device 160 is detailed hereafter with regard to FIG. 3. A headphone embodiment compliant with the third audio producing device 170 is detailed hereafter with regard to FIG. 5. A headset embodiment compliant with the third audio producing device 170 is detailed hereafter with regard to FIG. 6.

When used in conjunction with a headphone, the first 100, second 160 and third 170 audio producing devices are audio players, or any other devices capable of reproducing audio signals for listening. When used in conjunction with a headset, the first 100, second 160 and third 170 audio producing devices are mobile phones, or any other devices capable of providing two-way communications of audio signals.

Turning more specifically to FIG. 1A, the first audio producing device 100 comprises a connector 104 adapted to connect a headphone to the first audio producing device 100. The connector 104 is preferably a TRRS 4-pin 3.5 mm female connector.

The first audio producing device 100 further comprises an audio control unit 101. In at least one embodiment, the audio control unit 101 implements ANC functionality. In such a case, the first audio producing device 100 is intended to be used in conjunction with a headphone or a headset, as detailed hereafter, including at least one digital microphone per ear for capturing sound surrounding the person wearing the headphone or the headset.

The first audio producing device 100 further comprises an amplifying unit 102 and an adaptation unit 103.

The audio control unit 101 provides left and right stereo analog audio signals respectively via a link 110 and a link 111 to the amplifying unit 102. The left and right stereo analog audio signals provided by the audio control unit 101 consist of the left and right stereo audio signals intended to be heard by the person wearing the headphone, or the headset, connected to the first audio producing device 100 via the connector 104. However, when the audio control unit 101 implements ANC functionality, the left and right stereo analog audio signals provided by the audio control unit 101 consist of anti-noise signals superimposed on the left and right stereo audio signals intended to be heard by the person wearing the headphone, or the headset, connected to the first audio producing device 100 via the connector 104.

The amplifying unit 102 comprises first 122 and second 123 amplifiers adapted to respectively amplify the left and right stereo analog audio signals provided by the audio control unit 101. The amplifying unit 102 provides amplified left and right stereo analog audio signals respectively via a link 132 and a link 133 to the adaptation unit 103.

In an alternative embodiment (not shown), the amplifying unit 102 receives digital audio signals from the audio control unit 101, and the amplifying unit 102 comprises codec functionality for transforming the digital signals into analog audio signals before amplifying stages and for further providing these signals to the adaptation unit 103. In yet another embodiment, the aforementioned codec functionality is implemented by a stand-alone unit placed between the audio control unit 101 and the amplifying unit 102.

The adaptation unit 103 is adapted to separate digital data provided by digital microphones of the headphone, or a digital microphone of the headset, which is connected to the first audio producing device 100 via the connector 104, from the amplified left or right stereo analog audio signal provided by the amplifying unit 102. Indeed, as detailed hereafter with regard to FIGS. 2 and 4, the headphone or the headset is adapted to superimpose the digital data provided by said digital microphone(s) on top of the amplified left or right stereo analog audio signal provided by the amplifying unit 102.

On FIG. 1A, the digital data provided by said digital microphones are superimposed on top of the amplified left stereo analog audio signal provided by the first amplifier 122. Superimposition may in a variant be performed on top of the amplified right stereo analog audio signal provided by the second amplifier 123. The digital data resulting from the separating operation are provided by the adaptation unit 103 to the audio control unit 101 via a link 113, in order to allow the audio control unit 101 to generate the anti-noise signals when ANC functionality is implemented by the audio control unit 101, and in order to allow processing sound captured by the digital microphone of the headset when the first audio producing device 100 is used in conjunction with a headset including a digital microphone for capturing the voice of the person wearing the headset.

In one embodiment, the adaptation unit 103 comprises a first adaptation subunit 154 adapted to separate digital data from the analog audio signal. The first adaptation unit 154 is implemented when the headphone or headset is adapted to isolate only the edges of the signal representing the digital signal provided by each digital microphone of the headphone or headset, and to superimpose only said edges on top of the right or left stereo analog audio signal. The first adaptation unit 154 is schematically shown on FIG. 7B.

As shown on FIG. 7B, the first adaptation unit 154 comprises a D-Flip Flop circuit 752 to which the superimposed analog audio signal and digital data provided by the connector 104 are input. The first adaptation unit 154 may further comprise an amplifier 751 to amplify the signal at the input of the D-Flip Flop circuit 752. The D-Flip Flop circuit 752 allows restoring the square shape of the digital signal from the rectified edges.

Turning back to FIG. 1A, in one embodiment, the adaptation unit 103 comprises a second adaptation subunit 151 placed at the output of the first amplifier 122, i.e. the amplifier outputting the analog signal on top of which the digital data are superimposed. The second adaptation subunit 151 masks the output impedance of the first amplifier 122 to each digital microphone of the headphone or of the headset. The second adaptation subunit 151 presents high impedance for non-audible frequencies, e.g. frequencies greater than 20 kHz, and presents low impedance for audible frequencies, e.g. frequencies lower than 20 kHz.

According to another particular embodiment, the second adaptation subunit 151 consists of a resistor, for example of 160Ω. According to a particular embodiment, the second adaptation subunit 151 consists of a resistor in series with an inductance, for example of 47Ω and 10 μH respectively.

The adaptation unit 103 is further adapted to superimpose a clock signal, used to drive each digital microphone of the headphone or of the headset, which is connected to the first audio producing device 100 via the connector 104, on top of the amplified left or right stereo analog audio signal provided by the amplifying unit 102. The clock signal has an oscillating frequency significantly greater than the audible frequencies and is provided by the audio control unit 101 via a link 112. For instance, the clock signal has an oscillating frequency of 3.072 MHz. In a variant, the clock signal is provided to the adaptation unit 103 by a clock generator further providing the clock signal to the audio control unit 101.

On FIG. 1A, the clock signal is superimposed on top of the amplified right stereo analog audio signal provided by the second amplifier 123. Superimposition may in a variant be performed on top of the amplified left stereo analog audio signal provided by the first amplifier 122.

In one embodiment, the adaptation unit 103 comprises a third adaptation subunit 153 adapted to superimpose the clock signal on top of the analog audio signal. The third adaptation subunit 153 comprises a signal shape transforming unit adapted to transform the clock signal from a square shape to a sine shape. The third adaptation subunit 153 may further comprise a signal attenuating unit adapted to attenuate the amplitude of the clock signal, either before transformation in sine shape or after transformation in sine shape. The third adaptation subunit 153 may further comprise a DC (Direct Current) component removing unit adapted to remove a DC component to the sine transformed clock signal. The presence of the third adaptation subunit 153 supposes an inverse adaptation operation in the headphone, as detailed hereafter with regard to FIG. 2.

In one embodiment, the adaptation unit 103 comprises a fourth adaptation subunit 152 placed at the output of the second amplifier 123, i.e. the amplifier outputting the analog signal on top of which the clock signal is superimposed. The fourth adaptation subunit 152 masks the output impedance of the second amplifier 123 to the audio control unit 101. The fourth adaptation subunit 152 presents high impedance for non-audible frequencies, e.g. frequencies greater than 20 kHz, and presents low impedance for audible frequencies, e.g. frequencies lower than 20 kHz.

According to a particular embodiment, the fourth adaptation subunit 152 consists of a resistor, for example of 160Ω. According to another particular embodiment, the fourth adaptation subunit 152 consists of a resistor in series with an inductance, for example of 47Ω and 10 μH respectively.

The adaptation unit 103 is connected to the connector 104 by a link 141, via which the adaptation unit 103 provides a power supply signal to the headphone or headset. The power supply signal can be provided to the headphone or headset by another unit of the first audio producing device 100 than the adaptation unit 103, such as for instance a dedicated power supplying unit or the amplifying unit 102. The power supply signal is in the form of a DC (Direct Current) signal, for example of 1.8 V, or any other DC voltage suitable for driving the digital microphones.

The adaptation unit 103 is further connected to the connector 104 by a link 142, via which the adaptation unit 103 provides a ground signal to the headphone or headset via the connector 104. The ground signal can be provided to the headphone or headset by another unit of the first audio producing device 100 than the adaptation unit 103, such as for instance a dedicated ground connecting unit or the amplifying unit 102.

The adaptation unit 103 is further connected to the connector 104 by a link 143, on which the adaptation unit 103 provides to the headphone or headset, via the connector 104, the amplified right audio analog signal and the clock signal superimposed on top of the amplified right audio analog signal.

The adaptation unit 103 is further connected to the connector 104 by a link 144, on which the adaptation unit 103 provides to the headphone or headset, via the connector 104, the left audio analog signal, and on which the headphone provides to the adaptation unit 103 digital data provided by digital microphones of the headphone or headset.

Referring to a TRRS 4-pin 3.5 mm female connector, the links 141, 142, 143, 144 are connected to the respective four contacts of the connector 104.

Turning now to FIG. 1B, the second audio producing device 160 corresponds to a modified embodiment of the first audio producing device 100, adapted to operate with a headphone, or with a headset including an analog microphone for capturing the voice of the person wearing the headset. All items described hereinbefore with regard to FIG. 1A are present in the second audio producing device 160, but the amplifying unit 102 is replaced by an amplifying unit 162 and the adaptation unit 103 is replaced by an adaptation unit 163.

The amplifying unit 162 comprises the first and second 123 amplifiers and a third amplifier 121. The third amplifier 121 receives analog signals provided by the analog microphone of the headset, when said headset is connected to the second audio producing device 160 via the connector 104. The analog signals are provided from the connector 104 via the adaptation unit 163. The analog signals provided by the analog microphone are superimposed on top of the power supply signal on the link 141. The third amplifier 121 amplifies the analog signals provided by the analog microphone, for further processing by the second audio producing device 160, for instance in the scope of a phone conversation when the second audio producing device 160 is a phone. For example, the amplified analog signals are provided by the amplifying unit 162 to the audio control unit 101 via a link 109.

In one embodiment, the adaptation unit 163 comprises a fifth adaptation subunit 155 for separating the analog signals provided by the analog microphone from the power supply signal. The fifth adaptation subunit 155 may consist of a resistor, for example of 2.2 kΩ, placed between the link 141 and a power supply bias from which the power supply signal is obtained, and of a capacitor, for example of 1 μF, placed between the link 141 and the input of the amplifier 121.

The adaptation unit 163 is identical to the adaptation unit 103, except that the adaptation unit 163 is adapted to receive the analog signals provided by the analog microphone via the connector 104 and the link 141. The adaptation unit 163 is further adapted to provide said analog signals to the amplifying unit 162 via a link 131.

When an ANC headphone, such as described hereafter with regard to FIG. 2, is connected to the second audio producing device 160 instead of a headset, only the power supply signal is present on the link 141 and therefore no analog signals are provided to the third amplifier 121.

Turning now to FIG. 1C, the third audio producing device 170 corresponds to a modified embodiment of the first 100 and second 160 audio producing devices, adapted to operate with a headphone, or with a headset including a digital microphone for capturing the voice of the person wearing the headset. All items described hereinbefore with regard to FIG. 1A are present in the third audio producing device 170, but the adaptation unit 103 is replaced by an adaptation unit 173.

The adaptation unit 173 is adapted to receive the amplified left and right stereo analog audio signals from the amplifying unit 102. The adaptation unit 173 is further adapted to superimpose the clock signal on top of the amplified left and/or right stereo analog audio signals provided by the amplifying unit 102. The clock signal may therefore be superimposed on both left and right stereo analog audio signals, which enables easily providing the clock signal to each digital microphone in case of ANC functionality implementation in the audio producing device 170, and which furthermore enables balancing on both left and right analog speakers the possible impact of the clock signal on the left and right stereo analog audio signals.

In one embodiment, the adaptation unit 173 comprises the fourth adaptation subunit 152.

In one embodiment, the adaptation unit 173 comprises the third adaptation subunit 153.

The adaptation unit 173 is further adapted to separate the digital data provided by digital microphones of the headphone, or a digital microphone of the headset, which is connected to the first audio producing device 170 via the connector 104, from the power supply signal. Indeed, as detailed hereafter with regard to FIGS. 5 and 6, the headphone or the headset is adapted to superimpose the digital data provided by the digital microphone(s) on top of the power supply signal provided by the adaptation unit 173.

In one embodiment, the adaptation unit 173 comprises a sixth adaptation subunit 174 adapted to separate said digital data from the power supply signal. The sixth adaptation subunit 174 may consist of a resistor, for example of 10 kΩ, placed between the link 141 and the power supply bias from which the power supply signal is obtained, and of a DC offset correction circuit, for instance relying on an operational amplifier-based arrangement, placed between the link 141 and the link 113.

In the scope of FIGS. 1A, 1B and 1C, the adaptation subunits 151, 152, 153, 154, 155, 174 are implemented in the concerned adaptation unit 103, 163 or 173. Each adaptation subunit 151, 152, 153, 154, 155, 174 may however be a stand-alone unit in the concerned audio producing device 100, 160, 170.

FIG. 2 schematically represents a first headphone embodiment 200, which is suitable for being used in conjunction with either the first audio producing device 100 or the second audio producing device 160.

The headphone 200 comprises a connector 201 adapted to connect the headphone 200 to the connector 104. The connector 201 is preferably a TRRS 4-pin 3.5 mm male connector.

The headphone 200 comprises a left ear analog speaker 204 and a right analog ear speaker 205. The headphone 200 further comprises a left ear digital microphone 202 and a right ear digital microphone 203, for enabling ANC functionality in the audio producing device to which the headphone is connected.

The connector 201 is connected to a link 211, to a link 212, to a link 213 and to a link 214. Referring to a TRRS 4-pin 3.5 mm male connector, the links 211, 212, 213, 214 are connected to the respective four contacts of the connector 201.

The link 211 transports the left stereo analog audio signal provided by the audio producing device to which the headphone 200 is connected, and in a superimposed manner, the digital data provided by the digital microphones 202, 203. The link 212 transports the power supply signal provided by the audio producing device to which the headphone 200 is connected. The link 213 transports the ground signal provided by the audio producing device to which the headphone 200 is connected. The link 214 transports the right stereo analog audio signal provided by the audio producing device to which the headphone 200 is connected, and in a superimposed manner, the clock signal for driving the digital microphones 202, 203.

As already mentioned with regard to FIGS. 1A and 1B, the clock signal is superimposed on top of the right stereo analog audio signal. Superimposition may in a variant be performed on top of the left stereo analog audio signal. Identically, the digital data provided by the digital microphones 202, 203 are superimposed on top of the left stereo analog audio signal. Superimposition may in a variant be performed on top of the right stereo analog audio signal.

In a particular embodiment, the digital data rely on PDM (Pulse-Density Modulation). The digital data are provided by the digital microphones 202, 203 using a time shared access technique, such as a Time Division Mutliplex technique. For instance, the digital microphone 202 provides digital data on the rising edge of the clock signal and the digital microphone 203 provides digital data on the falling edge of the clock signal.

In one embodiment, more than two digital microphones are implemented in the headphone 200. In this case, all digital microphones are able to provide digital data using the time shared access technique.

The headphone 200 is adapted to superimpose the digital data, resulting from the sound capture performed by the digital microphones 202, 203, on top of the right or left stereo analog audio signal provided for respectively the right or left ear analog speaker by the audio producing device to which the headphone 200 is connected.

In one embodiment, the headphone 200 comprises a seventh adaptation subunit 221 adapted to superimpose the digital data on top of the right or left stereo analog audio signal. The seventh adaptation subunit 221 comprises means for attenuating the power of the digital data provided by the digital microphones 202, 203. In a particular embodiment, the arrangement shown on FIG. 7A is used to isolate only the edges of the signal representing the digital signal and to superimpose only said edges on top of the right or left stereo analog audio signal. The arrangement shown on FIG. 7A is intended to be used in conjunction with the arrangement shown on FIG. 7B. Implementing the seventh adaptation subunit 221 limits the impact of the digital data provided by the digital microphones 202, 203 onto the right or left stereo analog audio signal.

As shown on FIG. 7A, the digital output (via which the digital data are provided) of the digital microphone 202 is connected to one input of an AND gate 702 and to one input of an OR gate 703. The digital output of the digital microphone 202 is further connected to an R/C arrangement. The R/C arrangement consists of a resistor 706 in series with the digital output of the digital microphone 202, and of a capacitor 705 connected between the ground and the other side, compared to the digital microphone 202, of the resistor 706. For example, the resistor 706 as a value of 10Ω and the capacitor 705 as a value of 330 ρF. The output of the R/C arrangement is connected to another input of the AND gate 702 and to another input of the OR gate 703. The respective outputs of the AND gate 702 and of the OR gate 703 are connected to an XOR gate 701. The output of the XOR gate 701 is connected to the link 211 via another resistor 704, for example of 160 Ω.

Turning back to FIG. 2, in one embodiment, the digital microphones 202, 203 provide the digital data, representative of the sound captured by the digital microphones 202, 203, in a spread spectrum manner, which allows limiting the impact of the digital data onto the right or left stereo analog audio signals. It means that the energy level of the digital data in the audible frequencies range is negligible in view of the energy level of the left and right stereo analog audio signals. In a particular embodiment of this spread spectrum approach, the seventh adaptation subunit 221 may comprise a scrambling unit, also referred to as randomizing unit, adapted for energy dispersal on the frequency spectrum. Implementing such a scrambling unit supposes implementing a corresponding descrambling unit in the first adaptation unit 154.

The headphone 200 is further adapted to separate the clock signal used to drive the digital microphones 202, 203 and the right or left stereo analog audio signal provided for respectively the right or left ear analog speaker by the audio producing device to which the headphone 200 is connected.

In one embodiment, the headphone 200 comprises an eighth adaptation subunit 220 adapted to separate the clock signal from the right or left stereo analog audio signal. The eighth adaptation subunit 220 may comprise a DC component adding unit adapted to add a DC component from the clock signal received from the audio producing device to which the headphone 200 is connected. The DC component adding unit is for instance achieved by a resistor bridge powered by the power supply signal provided by the audio producing device to which the headphone 200 is connected. The eighth adaptation subunit 220 may further comprise an amplifier adapted to amplify the clock signal from which the DC component has been removed. The eighth adaptation subunit 220 comprises a signal shape transforming unit adapted to transform the clock signal from a sine shape to a square shape. In a particular embodiment, a Schmitt trigger is implemented in order to transform the clock signal from a sine shape to a square shape. The Schmitt trigger may then be powered using the power supply signal provided by the audio producing device to which the headphone 200 is connected.

The presence of the eighth adaptation subunit 220 supposes that the third adaptation subunit 153 is implemented in the audio producing device to which the headphone 200 is connected. By implementing the eighth adaptation subunit 220 in conjunction with the third adaptation subunit 153, the impact of the clock signal onto the right or left stereo analog audio signal is reduced by harmonics removal.

In one embodiment, the headphone 200 comprises a ninth adaptation subunit 222 adapted to isolate the audio input of the left ear analog speaker 204 from a DC component.

According to a particular embodiment, the ninth adaptation subunit 222 consists of a capacitor, for instance of 10 μF. According to another particular embodiment, the ninth adaptation subunit 222 consists of a capacitor in series with an inductance, for example of 100 μF and 100 μH respectively.

In one embodiment, the headphone 200 comprises a tenth adaptation subunit 223 adapted to isolate the audio input of the right ear analog speaker 205 from a DC component.

According to a particular embodiment, the tenth adaptation subunit 223 consists of a capacitor, for instance of 10 μF. According to another particular embodiment, the tenth adaptation subunit 223 consists of a capacitor in series with an inductance, for example of 100 μF and 100 μH respectively.

The arrangement shown on FIG. 2 therefore allows implementing ANC functionality, while limiting the amount of wires in the interface interconnecting the headphone and the audio producing device. TRRS 4-pin 3.5 mm connectors can thus be used to interconnect the headphone and the audio producing device.

FIG. 3 schematically represents a first headset embodiment 300, which is suitable for being used in conjunction with the second audio producing device 160. All items described hereinbefore with regard to FIG. 2 are present in the headset 300, but the headset 300 further comprises an analog microphone 306. The analog microphone 306 is typically intended to capture the voice of the person wearing the headset 300, when taking part in conversations handled by the second audio producing device 160.

The output of the analog microphone 306 is connected to the link 213. The headset 300 is therefore adapted to superimpose the analog audio signal, resulting from a sound capture by the analog microphone 306, onto the power supply signal provided by the second audio producing device 160 via the set of connectors 104, 201.

The arrangement shown on FIG. 3 therefore allows implementing an analog microphone based headset and ANC functionality, while limiting the amount of wires in the interface interconnecting the headset and the audio producing device. TRRS 4-pin 3.5 mm connectors can thus be used to interconnect the headset and the audio producing device.

FIG. 4 schematically represents a second headset embodiment 400, which is suitable for being used in conjunction with the first audio producing device 100.

The headset 400 comprises a digital microphone 406 intended to capture the voice of the person wearing the headset. Using a digital microphone instead of an analog microphone allows limiting the impact of interference on the signal that results from the sound capture by the microphone and that is provided for further processing to the audio providing device 100.

The headset 400 further comprises the left ear analog speaker 204 and the right ear analog speaker 205.

The headset 400 further comprises the connector 201, intended for connecting the headset 400 to the connector 104. As for FIGS. 2 and 3, the connector 201 is connected to the link 211, to the link 212, to the link 213 and to the link 214.

The link 211 transports the left stereo analog audio signal provided by the audio producing device 100, and in a superimposed manner, the digital data provided by the digital microphone 406. The link 212 transports the power supply signal provided by the audio producing device 100. The link 213 transports the ground signal provided by the audio producing device 100. The link 214 transports the right stereo analog audio signal provided by the audio producing device 100, and in a superimposed manner, the clock signal for driving the digital microphone 406.

As already mentioned, the clock signal is superimposed on top of the right stereo analog audio signal. Superimposition may in a variant be performed on top of the left stereo analog audio signal. Identically, the digital data provided by the digital microphone 406 are superimposed on top of the left stereo analog audio signal. Superimposition may in a variant be performed on top of the right stereo analog audio signal.

The headset 400 is adapted to superimpose the digital data, resulting from the sound capture performed by the digital microphone 406, on top of the right or left stereo analog audio signal provided for respectively the right or left ear analog speaker by the audio producing device 100.

In one embodiment, the headset 400 comprises the seventh adaptation subunit 221.

The headset 400 is further adapted to separate the clock signal used to drive the digital microphone 406 and the right or left stereo analog audio signal provided for respectively the right or left ear analog speaker by the audio producing device 100.

In one embodiment, the headset 400 comprises the eighth adaptation subunit 220.

In one embodiment, the headset 400 comprises the ninth adaptation subunit 222.

In one embodiment, the headset 400 comprises the tenth adaptation subunit 223.

The arrangement shown on FIG. 4 therefore allows implementing a digital microphone based headset, while limiting the amount of wires in the interface interconnecting the headset and the audio producing device. TRRS 4-pin 3.5 mm connectors can thus be used to interconnect the headset and the audio producing device.

FIG. 5 schematically represents a second headphone embodiment 500, which is suitable for being used in conjunction with the third audio producing device 170.

The headphone 500 comprises the left ear analog speaker 204 and the right analog ear speaker 205. The headphone 500 further comprises the left ear digital microphone 202 and the right ear digital microphone 203, for enabling ANC functionality in the audio producing device 170.

The headphone 500 further comprises the connector 201, adapted to connect the headphone 200 to the connector 104. As for FIGS. 2 to 4, the connector 201 is connected to the link 211, to the link 212, to the link 213 and to the link 214.

The link 211 transports the left stereo analog audio signal provided by the audio producing device 170. The link 212 transports the power supply signal provided by the audio producing device 170, and in a superimposed manner, the digital data provided by the digital microphones 202, 203. The link 213 transports the ground signal provided by the audio producing device 170. The link 214 transports the right stereo analog audio signal provided by the audio producing device 170, and in a superimposed manner, the clock signal for driving the digital microphones 202, 203.

As already mentioned with regard to FIG. 1C, the clock signal is superimposed on top of the right stereo analog audio signal. Superimposition may in a variant be performed on top of the left stereo analog audio signal, or on both left and right stereo analog audio signal.

In one embodiment, the headphone 500 comprises the eighth adaptation subunit 220.

In one embodiment, the headphone 500 comprises the ninth adaptation subunit 222 and/or the tenth adaptation subunit 223, according to whether the clock signal is superimposed by the audio producing device on top of respectively the left and/or right stereo analog audio signals.

As for the headphone 200, the headphone 500 may comprise more than two digital microphones.

The headphone 500 is adapted to superimpose the digital data, resulting from the sound capture performed by the digital microphones 202, 203, on top of the power signal provided by the audio producing device 170.

In one embodiment, the headphone 500 comprises an eleventh adaptation subunit 510 for extracting the power supply signal from the whole signal transported on the link 212, in order to power the digital microphones 222, 223. FIG. 5 shows two instances of the eleventh adaptation subunit 510, but a single eleventh adaptation subunit 510 may be shared by the digital microphones 222, 223.

In a particular embodiment, the eleventh adaptation subunit 510 consists of an inductance placed between the link 212 and the power supply input of each digital microphone 222, 223, and of a capacitor placed between the ground and the power supply input of each digital microphone 222, 223. For example, an inductance of 47 μH and a capacitor of 10 μF are used.

In one embodiment, the headphone 500 comprises a twelfth adaptation subunit 511 for superimposing the digital data provided by the digital microphones 222, 223 on top of the power supply signal provided by the audio producing device 170. FIG. 5 shows two instances of the twelfth adaptation subunit 511, but a single twelfth adaptation subunit 511 may be shared by the digital microphones 222, 223.

In a particular embodiment, the twelfth adaptation subunit 511 consists of a capacitor placed between the link 212 and the digital output of each digital microphone 222, 223, and of a resistor placed between the ground and the digital output of each digital microphone 222, 223. For example, a capacitor of 10 μF and a resistor of 10 kΩ are used.

The arrangement shown on FIG. 5 therefore allows implementing ANC functionality, while limiting the amount of wires in the interface interconnecting the headphone and the audio producing device. TRRS 4-pin 3.5 mm connectors can thus be used to interconnect the headphone and the audio producing device.

FIG. 6 schematically represents a third headset embodiment 600, which is suitable for being used in conjunction with the third audio producing device 170.

The headset 600 comprises the digital microphone 406, intended to capture the voice of the person wearing the headset. The headset 600 further comprises the left ear analog speaker 204 and the right ear analog speaker 205.

The headset 600 further comprises the connector 201, intended for connecting the headset 600 to the connector 104. As for FIGS. 2 to 5, the connector 201 is connected to the link 211, to the link 212, to the link 213 and to the link 214.

The link 211 transports the left stereo analog audio signal provided by the audio producing device 170. The link 212 transports the power supply signal provided by the audio producing device 170, and in a superimposed manner, the digital data provided by the digital microphone 406. The link 213 transports the ground signal provided by the audio producing device 170. The link 214 transports the right stereo analog audio signal provided by the audio producing device 170, and in a superimposed manner, the clock signal for driving the digital microphone 406.

As already mentioned with regard to FIG. 1C, the clock signal is superimposed on top of the right stereo analog audio signal. Superimposition may in a variant be performed on top of the left stereo analog audio signal.

In one embodiment, the headset 600 comprises the eighth adaptation subunit

In one embodiment, the headset 600 comprises the ninth adaptation subunit 222 or the tenth adaptation subunit 223, according to whether the clock signal used to drive the digital microphone 406 is superimposed by the audio producing device on top of respectively the left or right stereo analog audio signal.

The headset 600 is adapted to superimpose the digital data, resulting from the sound capture performed by the digital microphone 406, on top of the power signal provided by the audio producing device 170.

In one embodiment, the headset 600 comprises the eleventh adaptation subunit 510 for extracting the power supply signal from the whole signal transported on the link 212, in order to power the digital microphone 406.

In one embodiment, the headset 600 comprises the twelfth adaptation subunit 511 for superimposing the digital data provided by the digital microphone 406 on top of the power supply signal provided by the audio producing device 170.

The arrangement shown on FIG. 6 therefore allows implementing a digital microphone based headset, while limiting the amount of wires in the interface interconnecting the headset and the audio producing device. TRRS 4-pin 3.5 mm connectors can thus be used to interconnect the headset and the audio producing device.

1. An audio system comprising an audio producing device and an audio device of one of a headphone or a headset type, the audio device comprising left and right analog speakers, the audio producing device being adapted to transmit to the audio device left and right analog signals respectively to the left or right analog speakers, the audio producing device being further adapted to transmit to the audio device a power supply signal, wherein:
the audio producing device further comprises first processing logic configured to separate the digital data from one or more of said left analog signal, said right analog signal or said power supply signal for further processing by the audio producing device;
the audio producing device further comprises second processing logic configured to superimpose a clock signal arranged to drive at least a digital microphone on top of one or more of said left or right analog signal; and
the audio device further comprises a digital microphone and third processing logic configured to superimpose, on top of one or more of said left analog signal, said right analog signal or said power supply signal, digital data resulting from sound captures performed by the digital microphone;
the audio device further comprises fourth processing logic configured to separate the clock signal from said one or more of left or right analog signal to drive each digital microphone.

2-20. (canceled)

21. An audio producing device comprising a port configured to receive signals from an audio device one of a headphone or a headset type, said port adapted to transmit left and right analog signals respectively to the left or right analog speakers of the audio device, the audio producing device being further adapted to transmit to the audio device a power supply signal, said audio producing device comprising:
first processing logic configured to separate digital data from one or more of the left, the right analog signal or the power supply signal for further processing by the audio producing device; and
second processing logic configured to superimpose a clock signal arranged to drive at least one digital microphone of the audio device on top of said one or more of the left or right analog signal.

22. The audio producing device of claim 21, further comprising a first amplifier adapted to amplify one or more of the left or right analog signal before superimposing the clock signal, a second adaptation unit being present between said first amplifier and said second processing logic,
and said second adaptation unit being adapted to present a high impedance for non-audible frequencies and a low impedance for audible frequencies.

23. The audio producing device of claim 22, wherein said second adaptation unit comprises one of a resistor or a resistor in series with an inductance.

24. The audio producing device of claim 21, further comprising a third adaptation unit adapted to perform one or more of: i) transform the clock signal from a signal with a square shape to a signal having a principal component with a sine shape; ii) attenuate the clock signal; iii) remove a direct current component from the clock signal.

25-26. (canceled)

27. The audio producing device of claim 21, further adapted to separate the digital data from one of said left analog signal or said right analog signal.

28. The audio producing device of claim 27, further comprising a second amplifier adapted to amplify one or more of the left or right analog signal after separating the digital data, fourth adaptation unit being present between said second amplifier and said first processing logic, and said fourth adaptation unit being adapted to present a high impedance for non-audible frequencies and a low impedance for audible frequencies.

29. The audio producing device of claim 28, wherein said fourth adaptation unit comprises one of a resistor or a resistor in series with an inductance.

30. The audio producing device of claim 27, further configured to communicate with a headphone comprising at least two digital microphones and an analog microphone configured to capture a voice of a person wearing the headphone, the audio producing device further configured to performing audio noise cancellation based on said digital data provided by said at least two digital microphones, and to separate from the power supply signal an analog signal generated by a sound capture at the analog microphone.

31. The audio producing device of claim 21, further adapted to separate the digital data from said power supply signal.

32. The audio producing device of claim 31, further comprising a sixth adaptation unit adapted to separate said digital data from the power supply signal, wherein the sixth adaptation unit comprises: i) a resistor placed between a power supply bias from which the power supply signal is obtained and a link configured to transport the superimposed power supply signal and digital data, and ii) a direct current offset correction circuit placed between an audio control unit configured to receive said digital data and said link configured to transport the superimposed power supply signal and digital data.

33. The audio producing device of claim 21, wherein the port is of a Tip Ring Ring Sleeve 4-pin 3.5 mm connector type adapted to connect the audio producing device to the audio device.

34. An audio device of one of a headphone or a headset type comprising a port configured to connect to an audio producing device, the audio device comprising left and right analog speakers, the audio device being adapted to receive from the audio producing device left and right analog signals respectively at the left or right analog speakers, the audio device being further adapted to receive a power supply signal from the audio producing device, said audio device further comprising:
a digital microphone;
third processing logic configured to superimpose digital data resulting from sound captures performed by the at least one digital microphone on top of one or more of said left analog signal, said right analog signal or said power supply signal; and
fourth processing logic configured to separate a clock signal from said one or more of left or right analog signal to drive the digital microphone.

35. The audio device of claim 34, further comprising one or more of i) a ninth adaptation unit adapted to isolate the left analog speaker from a direct current component, or ii) a tenth adaptation unit adapted to isolate the right analog speaker from a direct current component.

36. The audio device of claim 35, wherein the one or more of said first adaptation unit or said second adaptation unit comprises one of a capacitor, or a capacitor in series with an inductance.

37. The audio device of claim 34, further comprising an eighth adaptation unit adapted to perform one or more of: i) transform the clock signal from a signal with a sine shape principal component to a signal with a square shape; ii) amplify the clock signal; iii) add a direct current component to the clock signal.

38-39. (canceled)

40. The audio device according to claim 34, further adapted to superimpose said digital data, resulting from sound captures performed by the digital microphone, on top of one or more of said left analog signal or said right analog signal.

41. The audio device of claim 40, further adapted to superimpose, in a spread spectrum manner, said digital data on top of one or more of said left analog signal or said right analog signal.

42. The audio device according claim 41, further comprising a scrambling unit for superimposing, in a spread spectrum manner, said digital data on top of one or more of said left analog signal or said right analog signal.

43. The audio device of claim 40, being a headset comprising at least two digital microphones allowing the audio producing device to perform audio noise cancellation and an analog microphone configured to capture a voice of a person wearing the headset, the headset comprising a processing circuit configured to superimpose onto the power supply signal an analog signal, resulting from a sound capture performed by the analog microphone.

44. The audio device of claim 40, being a headset comprising a digital microphone configured to capture a voice of a person wearing the headset.

45. The audio device of claim 34, further adapted to superimpose said digital data, resulting from sound captures performed by each digital microphone, on top of said power supply signal.

46. The audio device of claim 45, further comprising eleventh and twelfth adaptation units adapted to superimpose said digital data on top of the power supply signal, wherein the eleventh adaptation unit comprises: i) an inductance placed between a power supply input of each digital microphone and a link configured to transport the superimposed power supply signal and digital data, ii) a capacitor placed between the ground and the power supply input of each digital microphone, wherein the twelfth adaptation unit comprises: i) a capacitor placed between a digital output of each digital microphone and said link configured to transport the superimposed power supply signal and digital data, ii) a resistor placed between the ground and said digital output of each digital microphone.

47. The audio device of claim 45, being a headset comprising a digital microphone configured to capture the voice of a person wearing the headset.

48. The audio device of claim 34, comprising a connector of a Tip Ring Ring Sleeve 4-pin 3.5 mm type configured to connect the audio device to the audio producing device.
